(19) United States
(12) Patent Application Publication
(10) Pub. No.: US 2026/0203243 A1
(43) Pub. Date: Jul. 16, 2026

(54) SWITCH ARRAY ENABLING CONCURRENT CONNECIVITY BETWEEN HOST AND DEVICE CONTROLLERS AND THEIR RESPECTIVE PHYSICAL LAYER IN A USB CONTROLLER

(71) Applicant: MediaTek Singapore Pte. Ltd., Singapore (SG)

(72) Inventors: Zhanyong WANG, Anhui (CN); Yuping LENG, Anhui (CN)

(21) Appl. No.: 19/016,149

(22) Filed: Jan. 10, 2025

(51) Int. Cl. G06F 13/42; G06F 13/38

(52) U.S. Cl. CPC G06F 13/4282; G06F 13/382; G06F 2213/0042

(57) ABSTRACT

An electronic device for USB transmission includes a first physical layer, a second physical layer, a switch array, a host controller, and a device controller. The first physical layer transports a first data flow. The second physical layer transports a second data flow. The switch array is electrically connected to the first physical layer and the second physical layer. The host controller is electrically connected to the switch array. The device controller is electrically connected to the switch array. The switch array enables an electrical connection between the host controller and the first physical layer and enables an electrical connection between the device controller and the second physical layer at the same time. The first physical layer is a USB 3.0 physical layer, and the second physical layer is a USB 2.0 physical layer.

### FIELD OF THE INVENTION

The present invention relates to an electronic device, and, in particular, to an electronic device and a method for USB transmission.

### DESCRIPTION OF THE RELATED ART

Traditional USB 3.0 and above interfaces actually retain the original USB 2.0 interface in order to maintain backward compatibility. In order to simplify the design, on the physical link, the physical links for data transmission of USB 3.0 and USB 2.0 are separated and independent of each other. When acting in host mode, a Linux USB core stack can also separate a USB 3.0 bus and a USB 2.0 bus to cooperate with the separation of physical data links. Therefore, in traditional usage, these two separate physical links either play the role of host or device at the same time to maintain the backward compatibility promised by the USBIF Association.

In many applications of embedded systems (such as a vehicle-mounted device), some specific devices will be mounted on the system board to integrate product functions. These expansion products only need to work in USB 2.0 High speed mode or USB 3.0 super speed mode. In such cases, another physical data link reserved for backward compatibility is wasted.

### BRIEF SUMMARY OF THE INVENTION

An embodiment of the present invention provides an electronic device for Universal Serial Bus (USB) transmission that includes a USB controller. The USB controller includes a first physical layer, a second physical layer, a switch array, a host controller, and a device controller. The first physical layer transports a first data flow. The second physical layer transports a second data flow. The switch array is electrically connected to the first physical layer and the second physical layer. The host controller is electrically connected to the switch array. The device controller is electrically connected to the switch array. The switch array enables an electrical connection between the host controller and the first physical layer and enables an electrical connection between the device controller and the second physical layer at the same time. The first physical layer is a USB 3.0 physical layer, and the second physical layer is a USB 2.0 physical layer.

The electronic device further includes a processor. The processor is electrically connected to the host controller and the device controller. The processor receives a host interrupt from the host controller and receives a device interrupt from the device controller.

The electronic device further includes a memory controller. The memory controller is electrically connected to the host controller and the device controller. The memory controller transports the first data flow from or to the host controller, and transports the second data flow from or to the device controller.

The electronic device further includes a system clock. The system clock is electrically connected to the USB controller. The system clock sends a clock signal to the USB controller.

The electronic device further includes a first pair of transmission lines, a second pair of transmission lines, and a third pair of transmission lines. The first pair of transmission lines are electrically connected to the first physical layer, and includes a SSRX+ line and a SSRX- line. The second pair of transmission lines are electrically connected to the first physical layer, and include a SSTX+ line and a SSTX- line. The third pair of transmission lines are electrically connected to the second physical layer, and include a D+ line and a D- line.

According to the electronic device described above, the first pair of transmission lines and the second pair of transmission lines are electrically connected to a third party device. The third pair of transmission lines are electrically connected to an open jack, and the open jack is electrically connected to a consumer electronic device.

According to the electronic device described above, when the switch array enables an electrical connection between the host controller and the first physical layer and enables an electrical connection between the device controller and the second physical layer at the same time, the third party device becomes a USB host and the consumer electronic device becomes a USB device at the same time.

According to the electronic device described above, the switch array includes a first switch, a second switch, a third switch, and a fourth switch. The first switch is electrically connected between the first physical layer and the host controller. The second switch is electrically connected between the second physical layer and the host controller. The third switch is electrically connected between the first physical layer and the device controller. The fourth switch is electrically connected between the second physical layer and the device controller.

According to the electronic device described above, when the switch array enables an electrical connection between the host controller and the first physical layer and enables an electrical connection between the device controller and the second physical layer at the same time, the first switch is turned on, the second switch is turned off, the third switch is turned off, and the fourth switch is turned on.

According to the electronic device described above, the switch array enables an electrical connection between the host controller and the first physical layer and enables an electrical connection between the host controller and the second physical layer at the same time.

According to the electronic device described above, when the switch array enables an electrical connection between the host controller and the first physical layer and enables an electrical connection between the host controller and the second physical layer at the same time, the first switch is turned on, the second switch is turned on, the third switch is turned off, and the fourth switch is turned off.

An embodiment of the present invention also provides a method for USB transmission. The method is applied to an electronic device having a first physical layer, a second physical layer, a switch array, a host controller, and a device controller. The method includes the following steps. USB intellectual property (IP) is initialized. A first mode is applied to the first physical layer and a second mode is applied to the second physical layer. The first physical layer is switched to a host mode. The second physical layer is switched to a device mode. An operating system (OS) USB host core stack is registered with a host interrupt. An OS USB device core stack is registered with a device interrupt. The first mode is a USB 3.0 mode, and the second mode is a USB 2.0 mode.

According to the method described above, the step of switching the first physical layer to the host mode includes the following step. An electrical connection between the host controller and the first physical layer is enabled.

According to the method described above, the step of switching the second physical layer to the device mode includes the following step. An electrical connection between the device controller and the second physical layer is enabled.

### BRIEF DESCRIPTION OF THE DRAWINGS

FIG. 1 is a schematic diagram of an electronic device 100 in accordance with some embodiments of the present invention.

FIG. 2 is a schematic diagram of a scene where the electronic device 100 in FIG. 1 is disposed in accordance with some embodiments of the present invention.

FIG. 3 is a flow chart of a method for USB transmission in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to...”. Thus, when the terms “comprise”, “have” and/or “include” used in the present invention are used to indicate the existence of specific technical features, values, method steps, operations, units and/or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, and/or materials used in specific embodiments. However, the drawings should not be construed as defining or limiting the scope or properties encompassed by these embodiments. For example, for clarity, the relative size, thickness, and position of each layer, each area, and/or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without departing from the spirit of the present invention.

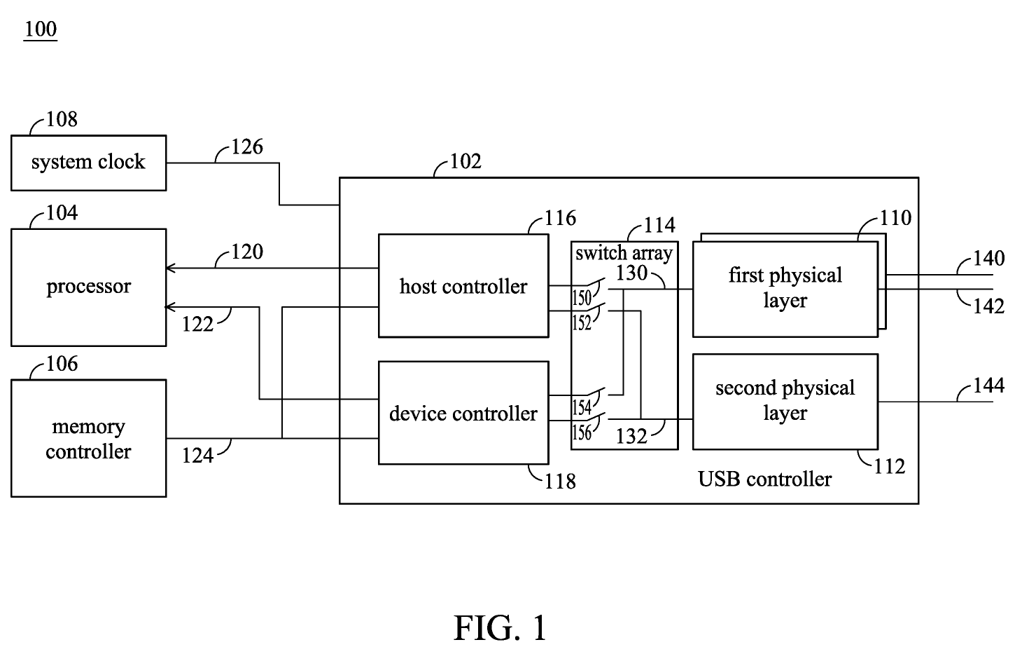

FIG. 1 is a schematic diagram of an electronic device 100 in accordance with some embodiments of the present invention. As shown in FIG. 1, the electronic device 100 includes a USB controller 102, a processor 104, a memory controller 106, and a system clock 108. In some embodiments, the electronic device 100 may be a chip, or a system-on-chip (SOC) in any electronic devices that support USB transmission, for example, a desktop, a laptop, a tablet, a smart phone, and a vehicle-mounted device, etc., but the present invention is not limited thereto. In some embodiments, the USB controller 102 includes a first physical layer 110, a second physical layer 112, a switch array 114, a host controller 116, and device controller 118. The first physical layer 110 transports a first data flow 130. The second physical layer 112 transports a second data flow 132. In some embodiments, the first physical layer 110 is a USB 3.0 physical layer, and the second physical layer 112 is a USB 2.0 physical layer. In some embodiments, the first physical layer 110 is a USB 2.0 physical layer, and the second physical layer 112 is a USB 3.0 physical layer. In some embodiments, the USB 3.0 physical layer may support, USB 3.0, USB 3.1, USB 3.2 (for example, that are USB 3.X), and USB 4.0 protocols, but the present invention is not limited thereto.

In some embodiments, when the first physical layer 110 is the USB 3.0 physical layer, and the second physical layer 112 is the USB 2.0 physical layer, the electronic device 100 further includes a first pair of transmission lines 140, a second pair of transmission lines 142, and a third pair of transmission lines 144. The first pair of transmission lines 140 are electrically connected to the first physical layer 110. The first pair of transmission lines 140 include, for example, a SSRX+ line and a SSRX- line. The second pair of transmission lines 142 are electrically connected to the first physical layer 110. The second pair of transmission lines 142 include, for example, a SSTX+ line and a SSTX- line. The third pair of transmission lines 144 are electrically connected to the second physical layer 112. The third pair of transmission lines 144 include, for example, a D+ line and a D- line. In some embodiments, the first pair of transmission lines 140 and the second pair of transmission lines 142 are electrically connected to a third party device, but the present invention is not limited thereto. The third pair of transmission lines 144 are electrically connected to an open jack, and the open jack is electrically connected to a consumer electronic device, but the present invention is not limited thereto.

The switch array 114 is electrically connected to the first physical layer 110 and the second physical layer 112. The host controller116 is electrically connected to the switch array 114. The device controller 118 is electrically connected to the switch array 114. In some embodiments, the switch array 114 enables an electrical connection between the host controller 116 and the first physical layer 110, and enables an electrical connection between the device controller 118 and the second physical layer 112 at the same time. When the switch array 114 enables an electrical connection between the host controller 116 and the first physical layer 110, and enables an electrical connection between the device controller 118 and the second physical layer 144 at the same time, the third party device becomes a USB host and the consumer electronic device becomes a USB device at the same time.

In detail, the switch array 114 includes a first switch 150, a second switch 152, a third switch 154, and a fourth switch 156. The first switch 150 is electrically connected between the first physical layer 110 and the host controller 116. The second switch 152 is electrically connected between the second physical layer 112 and the host controller 116. The third switch 154 is electrically connected between the first physical layer 110 and the device controller 118. The fourth switch 156 is electrically connected between the second physical layer 112 and the device controller 118. In some embodiments, when the switch array 114 enables an electrical connection between the host controller 116 and the first physical layer 110 and enables an electrical connection between the device controller 118 and the second physical layer 112 at the same time, the first switch 150 is turned on, the second switch 152 is turned off, the third switch 154 is turned off, and the fourth switch 156 is turned on.

In some embodiments, the switch array 114 enables an electrical connection between the host controller 116 and the first physical layer 110 and enables an electrical connection between the host controller 116 and the second physical layer 112 at the same time. When the switch array 114 enables an electrical connection between the host controller 116 and the first physical layer 110, and enables an electrical connection between the host controller 116 and the second physical layer 112 at the same time, the first switch 150 is turned on, the second switch 152 is turned on, the third switch 154 is turned off, and the fourth switch 156 is turned off.

When the switch array 114 enables an electrical connection between the host controller 116 and the first physical layer 110, and enables an electrical connection between the host controller 116 and the second physical layer 112 at the same time, the third party device becomes a USB host and the consumer electronic device becomes a USB host at the same time.

The processor 104 is electrically connected to the host controller 116 and the device controller 118. The processor 104 receives a host interrupt 120 from the host controller 116 and receives a device interrupt 122 from the device controller 118. In some embodiments, the processor 104 executes system software. The system software performs corresponding actions based on the host interrupt 120 from the host controller 116 and the device interrupt 122 from the device controller 118.

The memory controller 106 is electrically connected to the host controller 116 and the device controller 118. The memory controller 106 transports the first data flow 130 from or to the host controller 116 through a bus 124. The memory controller 106 transports the second data flow 132 from or to the device controller 118 through the bus 124. In some embodiments, the memory controller 106 is electrically connected to a memory (not shown in FIG. 1). The memory controller 106 writes the first data flow 130 and the second data flow 132 into the memory, or reads the first data flow 130 and the second data flow 132 from the memory.

The system clock 108 is electrically connected to the USB controller 102. The system clock 108 sends a clock signal 126 to the USB controller 102. In some embodiments, the system clock 108 includes an oscillator to generate the clock signal 126.

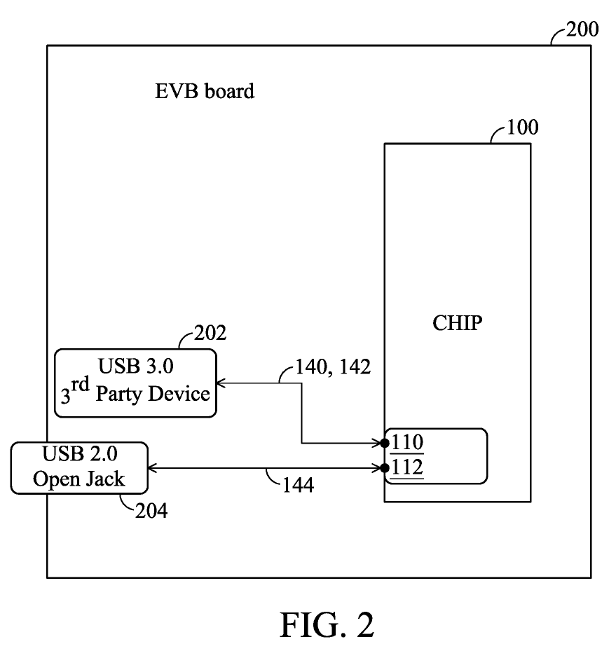

FIG. 2 is a schematic diagram of a scene where the electronic device 100 in FIG. 1 is disposed in accordance with some embodiments of the present invention. As shown in FIG. 2, the electronic device 100, for example, an SOC, is disposed on an EVB board 200. In some embodiments, the electronic device 100 includes the USB controller 102. The USB controller 102 is disposed in a USB intellectual property (IP). In some embodiments, the first physical layer 110, which is a USB 3.0 physical layer, is electrically connected to the first pair of transmission lines 140 and the second pair of transmission lines 142. The second physical layer 112, which is a USB 2.0 physical layer, is electrically connected to the third pair of transmission lines 144. The first pair of transmission lines 140 and the second pair of transmission lines 142 are electrically connected to a USB 3.0 third party device 202. The third pair of transmission lines 144 are electrically connected to an open jack 204, and the open jack 204 is electrically connected to a consumer electronic device (not shown). In some embodiments, the open jack 204 still supports backward compatibility. However, the USB 3.0 third party device 202 does not support backward compatibility.

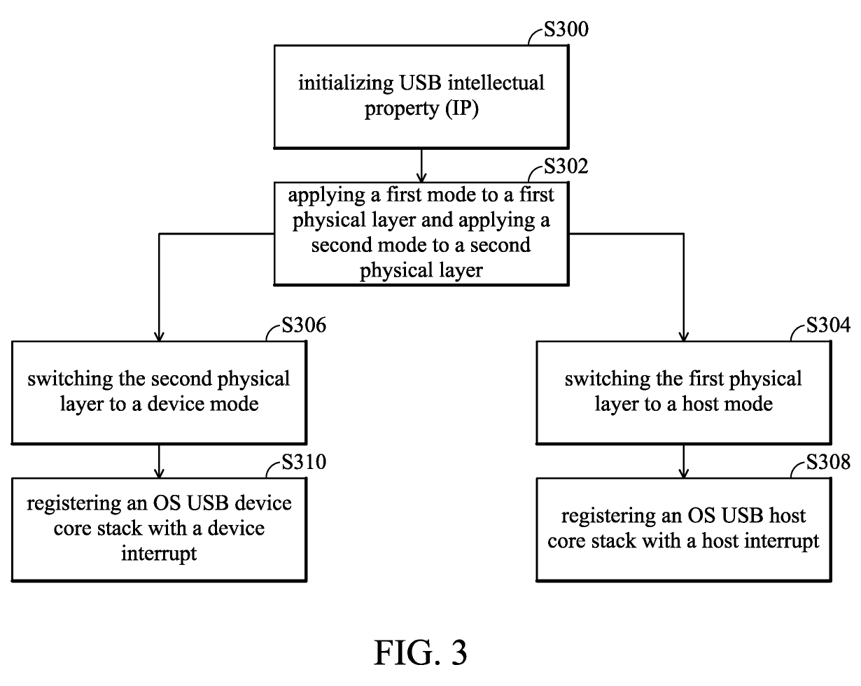

FIG. 3 is a flow chart of a method for USB transmission in accordance with some embodiments of the present invention. The method is applied to the electronic device 100 in FIG. 1. The method for USB transmission of the present invention includes the following steps. USB intellectual property (IP) is initialized (step S300). A first mode is applied to the first physical layer and a second mode is applied to the second physical layer (step S302). The first physical layer is switched to a host mode (step S304). The second physical layer is switched to a device mode (step S306). An operating system (OS) USB host core stack is registered with a host interrupt (step S308). An OS USB device core stack is registered with a device interrupt (step S310). In some embodiments, step S300 is executed by the USB controller 102 or the processor 104, but the present invention is not limited thereto. In some embodiments of step S302, the first mode is a USB 3.0 mode, and the second mode is a USB 2.0 mode. In some embodiments of step S302, the first mode is a USB 2.0 mode, and the second mode is a USB 3.0 mode. Step S302 is executed by the processor 104.

In some embodiments, step S304 and step S306 are executed by the USB controller 102. In some embodiments of step S304, the USB controller 102 or the switch array 114 enables an electrical connection between the host controller 116 and the first physical layer 110. In some embodiments of step S306, the USB controller 102 or the switch array 114 enables an electrical connection between the device controller 118 and the second physical layer 112. After step S308 is executed, the third party device that is connected to the first pair of transmission lines 140 and the second pair of transmission lines 142 becomes a USB host. After step S310 is executed, the consumer electronic device that is connected to the open jack 204 becomes a USB device. In some embodiments, steps S308 and S310 are executed at the same time.

The electronic device 100 and the method for USB transmission of the present invention use a single USB IP in a SOC to act as a USB host and a USB device at the same time, thereby reducing chip costs.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device for Universal Serial Bus (USB) transmission, comprising:
a USB controller, comprising:
a first physical layer, configured to transport a first data flow;
a second physical layer, configured to transport a second data flow;
a switch array, electrically connected to the first physical layer and the second physical layer;
a host controller, electrically connected to the switch array; and
a device controller, electrically connected to the switch array;
wherein the switch array enables an electrical connection between the host controller and the first physical layer and enables an electrical connection between the device controller and the second physical layer at the same time;
wherein the first physical layer is a USB 3.0 physical layer, and the second physical layer is a USB 2.0 physical layer.

2. The electronic device as claimed in claim 1, further comprising:
a processor, electrically connected to the host controller and the device controller, configured to receive a host interrupt from the host controller and receive a device interrupt from the device controller.

3. The electronic device as claimed in claim 1, further comprising:
a memory controller, electrically connected to the host controller and the device controller, configured to transport the first data flow from or to the host controller, and transport the second data flow from or to the device controller.

4. The electronic device as claimed in claim 1, further comprising:
a system clock, electrically connected to the USB controller, configured to send a clock signal to the USB controller.

5. The electronic device as claimed in claim 1, further comprising:
a first pair of transmission lines, electrically connected to the first physical layer, comprising a SSRX+ line and a SSRX- line;
a second pair of transmission lines, electrically connected to the first physical layer, comprising a SSTX+ line and a SSTX- line; and
a third pair of transmission lines, electrically connected to the second physical layer, comprising a D+ line and a D- line.

6. The electronic device as claimed in claim 5,
wherein the first pair of transmission lines and the second pair of transmission lines are electrically connected to a third party device;
wherein the third pair of transmission lines are electrically connected to an open jack, and the open jack is electrically connected to a consumer electronic device.

7. The electronic device as claimed in claim 6, wherein when the switch array enables the electrical connection between the host controller and the first physical layer and enables the electrical connection between the device controller and the second physical layer at the same time, the third party device becomes a USB host and the consumer electronic device becomes a USB device at the same time.

8. The electronic device as claimed in claim 1, wherein the switch array comprises:
a first switch, electrically connected between the first physical layer and the host controller;
a second switch, electrically connected between the second physical layer and the host controller;
a third switch, electrically connected between the first physical layer and the device controller; and
a fourth switch, electrically connected between the second physical layer and the device controller.

9. The electronic device as claimed in claim 8, wherein
when the switch array enables the electrical connection between the host controller and the first physical layer and enables the electrical connection between the device controller and the second physical layer at the same time, the first switch is turned on, the second switch is turned off, the third switch is turned off, and the fourth switch is turned on.

10. The electronic device as claimed in claim 8, wherein the switch array enables the electrical connection between the host controller and the first physical layer and enables an electrical connection between the host controller and the second physical layer at the same time.

11. The electronic device as claimed in claim 10, wherein
when the switch array enables the electrical connection between the host controller and the first physical layer and enables the electrical connection between the host controller and the second physical layer at the same time, the first switch is turned on, the second switch is turned on, the third switch is turned off, and the fourth switch is turned off.

12. A method for USB transmission, applied to an electronic device having a first physical layer, a second physical layer, a switch array, a host controller, and a device controller, the method comprising:
initializing USB intellectual property (IP);
applying a first mode to the first physical layer and applying a second mode to the second physical layer;
switching the first physical layer to a host mode;
switching the second physical layer to a device mode;
registering an operating system (OS) USB host core stack with a host interrupt; and
registering an OS USB device core stack with a device interrupt;
wherein the first mode is a USB 3.0 mode, and the second mode is a USB 2.0 mode.

13. The method as claimed in claim 12, wherein the step of switching the first physical layer to the host mode comprises:
enabling an electrical connection between the host controller and the first physical layer.

14. The method as claimed in claim 12, wherein the step of switching the second physical layer to the device mode comprises:
enabling an electrical connection between the device controller and the second physical layer.
